(19) United States
(12) Patent Application Publication
(10) Pub. No.: US 2026/0360248 A1
(43) Pub. Date: Nov. 12, 2026

(54) BATTERY LOCATING SYSTEM

(71) Applicant: Chenlong Tan, Irvine, CA (US)

(72) Inventor: Chenlong Tan, Irvine, CA (US)

(21) Appl. No.: 19/670,502

(22) Filed: May 7, 2026

Related U.S. Application Data
(60) Provisional application No. 63/802,420, filed on May 8, 2025.

(51) Int. Cl. G08B 21/24; G08B 7/06

(52) U.S. Cl. CPC G08B 21/24; G08B 7/06

(57) ABSTRACT

A battery locating system includes a microcontroller configured to generate a battery locating event, an antenna coupled to the microcontroller and structured to send a representation of the battery locating event to one or more batteries wirelessly coupled to the antenna through a first wireless communication network, and the one or more batteries structured to generate a battery locating signal when the one or more batteries receives the battery locating event. Methods are also described.

### CROSS-REFERENCE TO RELATED APPLICATIONS

This application is a non-provisional of and claims benefit from U.S. Provisional Patent Application No. 63/802,420, filed May 8, 2025, entitled BATTERY LOCALIZATION SYSTEM, the teachings of which are incorporated by reference herein.

### TECHNICAL FIELD

The subject matter is related to a battery system and, more particularly, to a system for locating batteries within a local, multi-device environment.

### BRIEF DESCRIPTION OF THE DRAWINGS

FIG. 1 is a functional block diagram of a battery locating system, according to an example configuration.

FIG. 2 is a functional block diagram of system components located on an example battery in the battery locating system, according to embodiments.

FIG. 3 is a functional block diagram of system components located on another example battery in the battery locating system, according to embodiments.

### DETAILED DESCRIPTION

As described herein, aspects are directed to a battery locating system. More particularly, aspects are directed to a system for generating a signal that allows a user to locate or otherwise identify specific batteries of varying types within a local, multi-device environment.

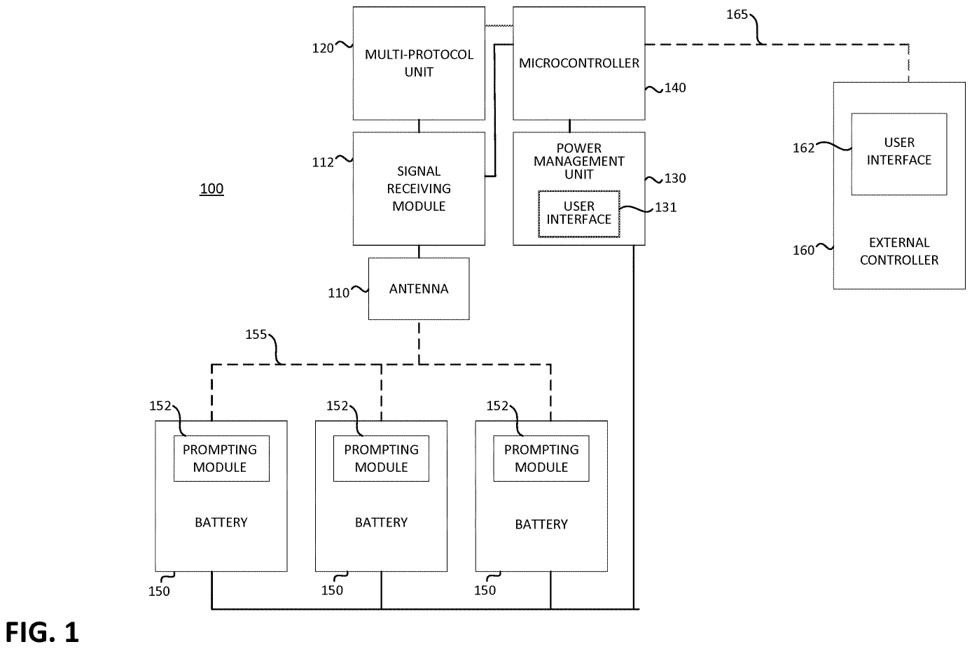

FIG. 1 is a functional block diagram of a battery locating system 100, according to an example configuration of the disclosed technology. As shown, a battery locating system 100 is in communication with a local environment of one or more batteries 150. Although the example system shown in FIG. 1 illustrates three batteries, still other configurations of the battery locating system 100 may be used with a greater or fewer number of batteries. Additionally, it should be understood that not all of the batteries 150 need be of the same type. That is, a variety of standard-size batteries and larger, removable batteries can be implemented to form a variety of local, multi-device environments. In configurations, battery locating system 100 supports standard dry cell battery types—such as AA, AAA, C, D, 9V, and coin cells—as well as removable, high-capacity batteries—such as lithium-ion packs or other battery technologies commonly used with cordless power tools. The term “battery” as used herein encompasses batteries with any number of individual battery cells. Oftentimes a battery includes only a single cell, but other times a battery may be formed of multiple, individual cells electrically coupled to one another to create a single “battery”. Batteries are often specified in terms of voltage and amp-hours. Modifying the number of individual cells contained in a battery and selecting in which way such cells are connected to one another allows batteries to be produced to fit many varying needs and purposes.

The battery locating system 100 includes an ability to wirelessly communicate with one or more batteries 150, in configurations. Specifically, the battery locating system 100 includes an antenna 110 for receiving signals from the one or more batteries 150 over a wireless communication network 155, and each battery includes an antenna for sending and receiving signals over the wireless communication network.

More particularly, in configurations such as the example system shown in FIG. 1, the battery locating system 100 has a signal receiving module 112 for processing signals received at the antenna 110 over the communication network 155 from the one or more batteries 150. The signal receiving module 112 is configured to support the reception of signals according to a variety of communication protocols that the communication network 155 may use. For instance, in configurations, the communication network 155 uses, and the signal receiving module 112 supports, one or more of radio frequency (RF), infrared (IR), ultra-wideband (UWB), Bluetooth®, Bluetooth® Low Energy (BLE), Zigbee, Z-Wave, and/or Wi-Fi communication protocols. In some embodiments, proprietary wireless protocols may be used, or such proprietary protocols may be used in combination with existing protocols. For example, the communication network 155 may use proprietary data codes carrying instructions and data all of which are carried in, for example, data packets that are transmitted using a Bluetooth® protocol, or any of the other wireless protocols described above. Also, the signal receiving module 112 may be configured to implement a single wireless protocol or a combination of wireless protocols. For instance, in some configurations, a multi-protocol unit 120 supports multiple communication protocols and allows for combining protocols or otherwise switching between particular protocols used to communicate with the one or more batteries 150 over the communication network 155. Although shown in FIG. 1 as a group of one or more batteries 150, in some embodiments any or all of the batteries 150 may communicate to the signal receiving module over different wireless networks, and even different types of wireless networks.

Additionally, each of the one or more batteries 150 includes a prompting module 152. In configurations, when activated, the prompting module 152 transmits signals from the one or more batteries 150 to be received at or received from the signal receiving module 112. The prompting module 152 is also configured to receive signals from other components in the battery locating system 100. As will be discussed in further detail below, the prompting module 152 is further configured to generate human-perceptible prompts on its associated battery 150 to assist a user in locating a target battery within the multi-device environment. That is, each prompting module 152 is configured to, when it receives a locating signal through the battery locating system 100, generate audible, visible, and/or haptic prompts to indicate to a user where the particular battery 150 generating the prompt is located. Furthermore, each prompting module 152 may be configured to transmit signals indicating status information related to a particular one of the one or more batteries 150.

As shown, a power management unit 130 is electrically connected with the one or more batteries 150 to monitor power connections, charge the one or more batteries 150, and otherwise control power functions of the one or more batteries 150. In configurations, the power management unit 130 is optimized for a wide variety of battery types, ranging from compact batteries like coin cells to high-capacity batteries for power tools. The battery locating system 100 also includes a microcontroller 140 to manage signal filtering, channel verification, and control logic for the overall system. Finally, as shown in FIG. 1, the battery locating system 100 may include an external controller 160. In configurations, the external controller 160 is a mobile device or remote control in wireless communication with the battery locating system 100, having a user interface 162 to allow a user to control functions of battery locating system 100. The external controller 160 communicates to the battery locating system 100 through a wireless communication network 165, which may be a different communication network, or use a different communication protocol, than the communication network 155 between the battery 150 and the signal receiving module 112. The external controller 160 may be an application running on a mobile device, such as a mobile phone or other remote device specifically configured to interface with the battery locating system 100. In some embodiments the power management unit 130 may include a user interface 131 by which a user can locally control the battery locating system 100 without the need for an external controller 160.

Configurations of the battery locating system 100 allow for a user to locate a specific battery 150 within an environment of multiple batteries. Configurations further allow the user to review status information regarding particular batteries and manage device groupings. Because configurations of the disclosed technology support a wide variety of battery types in combination, as well as a variety of communication protocols interchangeable based on need, the disclosed battery locating system 100 offers an efficient and accurate system for tracking and locating batteries 150 in multi-device environments of various scales. For instance, configurations of the disclosed system are scalable for multi-device environments ranging in size from personal household tool kits to large scale tool warehouses.

To track and locate particular batteries 150 within a multi-device environment, each of the one or more batteries is identified with a unique identifier, such as a channel ID, within the system. In configurations, each of the one or more batteries 150 is programmed to have a fixed channel ID at the time of manufacture, which is referred to herein as static assignment. In still other configurations, channel IDs can be assigned or updated via a pairing process with the external controller 160 or through the user interface 131 of the power management unit 130. That is, a user can assign their own channel IDs to particular batteries within the overall system, referred to herein as dynamic assignment. When a user implements dynamic assignment, the one or more batteries 150 are configured to enter a pairing mode, and the user may select a “Set ID” command via external controller 160 or user interface 131. Once the user has selected channel IDs for the one or more batteries 150, the one or more batteries store their respective channel IDs in non-volatile memory within the battery itself.

With channel IDs assigned to the one or more batteries 150, either statically or dynamically, a specific battery 150 of the collective of batteries can be located. More particularly, the external controller 160 can be used to transmit a query signal specifying the channel ID of a battery to be located. The query signal is received by the microcontroller 140, which then generates a representation of the query signal, such as particular codes sent over the wireless communication network 155 to the specified one or more batteries 150. Then, when one of the one or more batteries 150 receives the codes representing the query signal, the particular battery having the matching channel ID activates its prompting module 152 to assist the user in locating that battery. Other codes representing other functions and operations may also be sent over the wireless communication network 155 to send queries, commands, or data, described herein, between the one or more batteries and other components of the battery locating system 100.

As previously discussed, each prompting module 152 of each of the one or more batteries 150 is configured to generate a human-perceptible prompt on the battery on which the prompting module is located. In configurations, the prompt may be an audible, visible, or/or haptic response. The prompt may be a combination of any or all of the audible, visible, or haptic elements. For instance, the prompting module 152 may include an audio buzzer or other sound-generating device to produce audio signals. In some examples, the prompting module 152 is configured to emit a beep or series of beeps, which may vary in terms of frequency, rhythm, and duration.

For instance, when the prompting module 152 of a particular battery is first activated and the user is some distance away from that particular battery, the corresponding prompting module 152 may emit a series of low-frequency beeps that periodically repeat at a slow rate. This low-frequency, slow-paced beeping indicates to the user that the target battery is relatively far away from the user. As the user approaches carrying the external controller 160 in communication with the target battery, the prompting module 152 is configured to increase either or both of the frequency and pace of the beeping. Accordingly, as the user approaches the target battery and reaches a moderately close distance from the battery, the prompting module 152 begins emitting a series of beeps at a medium-frequency repeating at a medium pace. As the user continues toward the target battery, the prompting module 152 may increase frequency and pace once again, emitting a high-frequency beeping at a fast past to indicate that the target is very close.

In some configurations, still other frequencies and paces of beeping are used to communicate other environmental factors as the user locates the target battery. For example, in some configurations, longer pulses of sound—rather than short beeps—at a low-frequency and slow repeating pace may indicate that an obstruction exists between the target battery and the external controller 160. In other words, longer pulses like these may indicate to a user that the target battery is blocked by another object or is otherwise out of the user's line of sight. In this way, configurations of the disclosed system implementing audible prompts are designed to be clearly perceptible regardless of whether the target battery is openly exposed or is stored inside a case, drawer, toolbox, or other storage container. Additionally, while an auditory system using beeps and pulses at different frequencies and paces has been described thus far, it should be understood that still other auditory systems can be implemented to communicate similar information to a user regarding target distance and potential obstructions. For instance, any or all of a pitch of the beep, duration of the beep, and/or delay period between successive beeps may be controlled to communicate particular information to the user. In those batteries 150 including haptic feedback, any or all of the techniques described above may be performed by the haptic feedback unit, which operates to vibrate the individual battery 150 itself. Such haptic feedback may also generate noise when the battery 150 vibrates near other batteries or within its battery receiver.

The prompting module 152 is further configured to provide visible prompts. For example, in some configurations, prompting module 152 includes a light-generating unit, such as an LED or series of LEDs. In such configurations, the light-generating unit is configured to emit different colors and flash or blink at different rates depending on a user's distance from the target battery. In some examples, the light-generating unit of the prompting module 152 is configured to emit a red light when the user is far from the target battery, a yellow light when the user is a moderate distance from the target battery, and a green light when the user is near the target battery.

In additional or alternative examples, the light-generating unit of the prompting module 152 is configured to blink at a slow pace, such as one flash per second, when the user is far from the target battery. The light-generating unit may then blink at a medium pace of two flashes per second when the user is a moderate distance from the target battery, and a fast pace of five flashes per second when the user is near the target battery. In still other example configurations, a combination of color changes and blinking rates can be used to communicate information regarding the target distance with the user. That is, at a far distance from the target battery, the light-generating unit may blink red at one flash per second, then change to blinking yellow at two flashes per second as the user approaches, and finally change to blinking green at five flashes per second when the user is near the target battery. In some configurations, the brightness of the light from the light-generating unit adapts to ambient light conditions to allow the user to see the light regardless of the ambient conditions. The particular colors and frequency of blinks described above is representative, and other combinations of colors and frequencies may also be used in embodiments.

As mentioned, each prompting module 152 of each of the one or more batteries 150 can be further configured to wirelessly communicate information regarding the target battery. In other words, each prompting module 152 can send wireless signals to the power management unit 130, and, further, through the communication network 165 to the external controller 160 such that information regarding battery activation, position, and/or status can be displayed to the user. Such information may additionally or alternatively be shown on the user interface 131. In some configurations, a user selects a battery having a particular channel ID using a user interface of the external controller 160 or user interface 131. The user interface 131 or 162 may then display a message to the user indicating the channel ID of the battery, the quality of the signal received from the battery, an estimation of physical proximity to the battery, acknowledgment of any commands that have been sent to the battery and executed, and information regarding the battery's voltage, charge level, or usage status. In such configurations, signal quality is provided based on a received signal strength indicator (RSSI), time-of-flight (TOF), or other appropriate signal metric depending on the implemented communication protocol or combination of protocols. Additionally, estimation of physical proximity is provided to the user based on an estimated distance, an estimated direction, or combination of the two.

Each prompting module 152 of each of the one or more batteries 150, in configurations, is activated based on signal recognition events. For instance, in hardware-based systems, decoder and circuit logic is used for a basic trigger response. In additional or alternative configurations, a programmed microcontroller implements software to interpret signals for more advanced behavior. The microcontroller, in this way, performs functions of filtering signals, transmitting feedback to a user, and controlling patterns.

Signals that are transmitted to activate each prompting module 152 can activate the modules based on a variety of triggers. For example, as discussed above, a transmitted signal may carry a unique channel ID, and therefore the prompting module 152 of the battery having that unique channel ID will be activated upon reception of the signal. Additionally, or alternatively, a particular command type may be embedded in the signal, dictating the particular response of the prompting module 152 once activated. The signal may include a command that the prompting module “beep only” or “flash only,” for instance, and therefore the transmitted signal determines the type of prompt generated for the user who is locating a particular battery. Furthermore, some example activation signals activate prompting modules based on environmental criteria, such as signal strength. Put differently, an activation signal may activate only those prompting modules 152 above a minimum signal strength threshold with the external controller 160.

As mentioned, power management unit 130 is electrically connected with the one or more batteries 150 to control power functions of the one or more batteries 150. When the prompting modules 152 of the one or more batteries 150 are inactive, the power management unit 130 maintains each of the prompting modules in a low power, standby mode such that they remain available to receive activation trigger signals. Upon activation of a prompting module 152, the power management unit 130 is configured to supply a greater amount of power, driving the prompting module 152 in an event-driven operation mode for a short cycle to preserve battery life. Additionally, or alternatively, components of each prompting module 152 may be driven with adaptive duty cycling. For instance, the power management unit 130 may be configured to provide timed pulses to the sound-generating unit and/or light-generating unit to reduce continuous power draw.

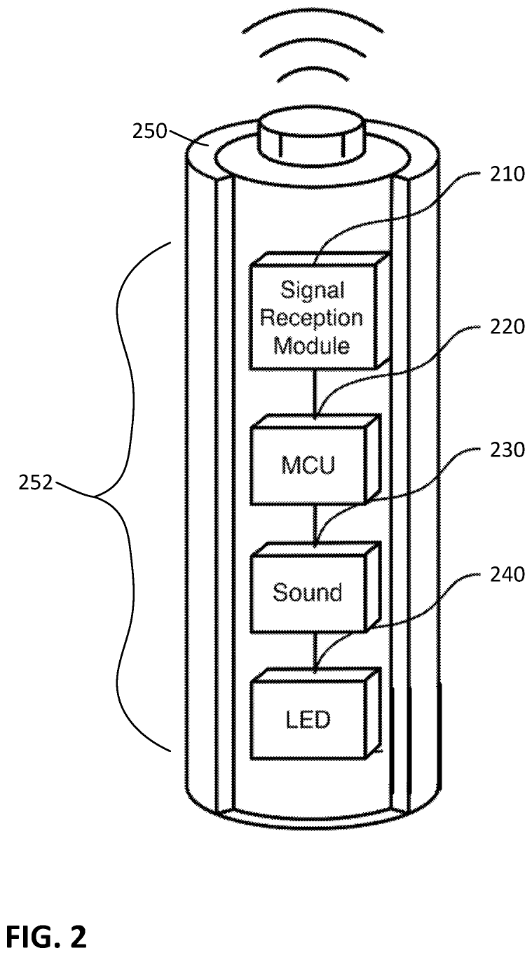

FIG. 2 is a functional block diagram of system components of a prompting module 252 located on an example battery 250 in the battery locating system 100, according to embodiments. The battery 250 illustrated in FIG. 2 may be an example of any of the one or more batteries 150 illustrated and described above with reference to FIG. 1. Also, the prompting module 252 may be an example of any of the prompting modules 152 described above, meaning the prompting module 252 performs the same actions and acts in the same way as the prompting module 152 described above. Although illustrated as a long, cylindrical type, the example battery 250 may be of any outward physical appearance, such as rechargeable batteries used for power equipment.

As illustrated in FIG. 2, the prompting module 252 includes a signal reception module 210 which includes the antenna described above, as well as the communication hardware used to wirelessly communicate between the battery 250 and the battery locating system 100. The signal reception module 210 includes the necessary circuitry to communicate using any or all of the radio frequency (RF), infrared (IR), ultra-wideband (UWB), Bluetooth® Low Energy (BLE), Zigbee, Z-wave, and Wi-Fi communication protocols described above. It is not necessary that every signal reception module 210 include all of these separate communication protocols. In some embodiments which of the protocols are supported in any particular signal reception module 210 may be implementation specific. The antenna within the signal reception module 210 of the battery 250 may be tailored to the housing material of the battery 250 itself. For example, the antenna may be tailored to plastic battery housings in the case of batteries for power tools or may be tailored to metal housings in the case of coin cells or standard-sized metal batteries.

An optional microcontroller unit MCU 220 may be used to manage signal filtering, perform channel verification, and generally operate any control logic necessary to operate the battery 250 within the battery locating system 100. The MCU 220 is powered by the battery 250 to which it is attached. In embodiments the MCU 220 operates on ultra-low power to save battery resources. In configurations, either the fixed channel ID or the dynamically assigned ID for each battery 250, described above, may be programmed and stored into memory of the MCU 220. The memory may be volatile memory, such as RAM (Random Access Memory), or non-volatile memory such as ROM (Read Only Memory). In other embodiments the memory may be non-volatile, programmable, memory, such as EEPROM (Electrically Erasable Programmable Read-Only Memory) memory or other NVRAM (Non-Volatile Random-Access Memory) memory.

The prompting module 252 of FIG. 2 further includes one or more sound-generating units 230 and light-generating units 240 that include the hardware used to effectuate the sound and light positioning and communication described above. For example, the sound-generating unit 230 may include a speaker, buzzer, or other sound generating device. The light-generating unit 240 may include one or more LEDs, described above, or other light-generating devices, such as display screens.

With configurations of the disclosed battery locating system, a user is able to efficiently and easily locate a particular device within a multi-device environment. And, because configurations of the disclosed system support a variety of battery types and combinations of battery types, as well as a variety of communication protocols and combinations of protocols, the system is scalable and adaptable for various uses. That is, configurations of the disclosed system can be implemented to track the locations of batteries and communicate accurate information regarding those batteries whether deployed for a small household collection of power tools or a large warehouse. Additionally, because a number of human-perceptible prompts are available for communicating battery location to a user, configurations of the locating system are adaptable and allow a user to implement prompts that are most useful for their particular environment.

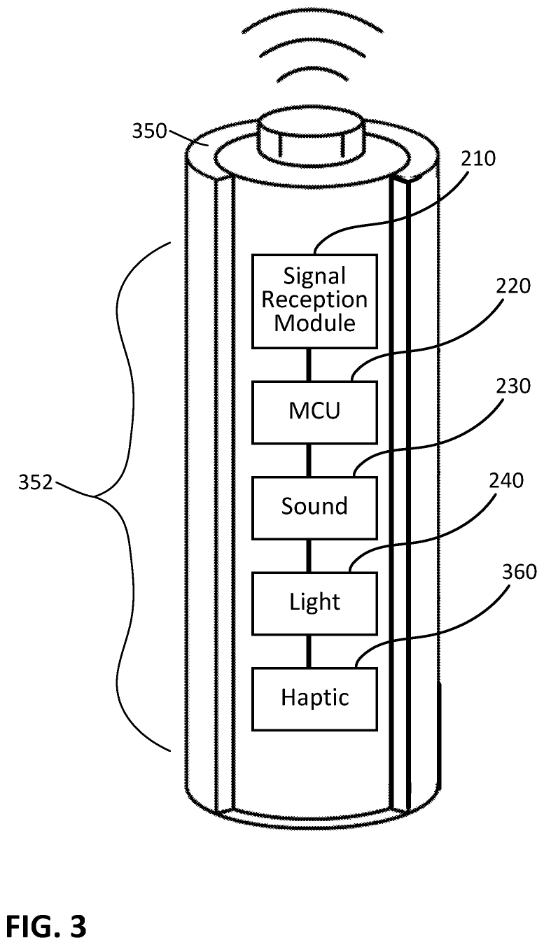

FIG. 3 is a functional block diagram of system components of a prompting module 352 located on an example battery 350 in the battery locating system 100, according to embodiments. The battery 350 illustrated in FIG. 2 may be an example of any of the one or more batteries 150 illustrated and described above with reference to FIG. 1. Different than the battery 250 illustrated in FIG. 2, the prompting module 352 further includes a haptic unit 360. The haptic unit 360, when controlled to operate by the prompting module 352, causes the battery 350 to vibrate. Such vibration may be sensed by the user when the vibrating battery 350 is touched by a user. Additionally, as described above, the vibration may cause the battery 350 to produce noise as the vibrating battery touches nearby structures, such as a battery receiver into which the battery is inserted. Additionally, the vibrating battery 350 may produce noise as it touches adjacent batteries.

With reference to FIGS. 2 and 3, note that not all batteries 150, 250, 350, need include all of the forms of generating a location signal. For example, some batteries 150 may include only a light-generating unit 240, and not include any sound-generating units 230. Other batteries may include only sound-generating units 230, but no light-generating units 240. Yet other batteries may include only haptic units 360, which are structured to vibrate when activated. Thus, batteries 150 according to embodiments may include a single one of the sound-generating units 230, light-generating units 240, or haptic units 360. Other batteries may include two of the above-described units, while still others may include all three of such units.

Although the prompting modules 152, 252, and 352 are illustrated as being integrated into their respective batteries, in some embodiments the prompting modules may be embodied by physical devices that are separate from, but electrically connected to, the batteries themselves. For example, a prompting module may be a separate device that may be electrically connected to a standard battery, and powered by the standard battery. In other words, the prompting module need not be integrated into specialized batteries, but may be an accessory used in conjunction with standard batteries. In some embodiments prompting modules 152, 252, and 352 are physically attached to the outside of a standard battery, or located near the battery. In such cases, the locating signals described above may be generated by the prompting modules themselves, and not necessarily by the batteries to which such prompting modules are connected. In other embodiments, such as those described above, the prompting modules 152, 252, and 352 are integrated into or on their host batteries themselves.

Aspects of the disclosure may operate on a particularly created hardware, on firmware, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

What is claimed is:

1. A battery locating system, comprising:
a microcontroller configured to generate a battery locating event;
an antenna coupled to the microcontroller and structured to send a representation of the battery locating event to one or more batteries wirelessly coupled to the antenna through a first wireless communication network; and
the one or more batteries structured to generate a battery locating signal when the one or more batteries receives the battery locating event.

2. The battery locating system according to claim 1, in which each of the one or more batteries are associated with a unique identifier.

3. The battery locating system according to claim 2, in which the unique identifier may be a static identifier or a dynamic identifier.

4. The battery locating system according to claim 1, in which the battery locating signal is a light.

5. The battery locating system according to claim 1, in which the battery locating signal is a sound.

6. The battery locating system according to claim 1, in which the battery locating signal is a haptic signal.

7. The battery locating system according to claim 1, further comprising an external controller wirelessly coupled to the microcontroller through a second wireless communication network.

8. The battery locating system according to claim 7, in which the microcontroller is structured to generate the battery locating event based on a signal received from the external controller over the second wireless communication network.

9. The battery locating system according to claim 7, in which the external controller includes a user interface through which a user can control the microcontroller.

10. The battery locating system according to claim 1, in which the microcontroller is coupled to a power management unit structured to generate signals used by the microcontroller to cause the microcontroller to generate the battery locating event.

11. The battery locating system according to claim 10, in which the power management unit includes a user interface through which a user can control the microcontroller.

12. The battery locating system according to claim 1, in which the first wireless communication network is a network that communicates using one or more of radio frequency (RF), infrared (IR), ultra-wideband (UWB), Bluetooth®, Bluetooth® Low Energy (BLE), Zigbee, Z-Wave, and Wi-Fi communication protocols, or proprietary protocols.

13. The battery locating system according to claim 12, further comprising a protocol unit structured to decode wireless signals received over the first wireless communication network.

14. A method of generating a locating signal on one or more batteries of a plurality of batteries, the method comprising:
generating a battery locating event;
sending a representation of the battery locating event to the one or more batteries through a first wireless communication network to the one or more batteries; and
generating the locating signal by the one or more batteries when the one or more batteries receives the battery locating event.

15. The method according to claim 14, in which the locating signal is a light signal, a sound signal, or a haptic signal.

16. The method according to claim 14, in which each of the one or more batteries includes a unique identifier.

17. The method according to claim 16, in which the unique identifier is a static identifier or a dynamic identifier.

18. The method according to claim 14, in which generating a battery locating event comprises:
receiving a signal from a remote device over a second wireless communication network; and
generating the battery locating event based on the received signal.

19. The method according to claim 18, further comprising generating the signal from the remote device based on commands entered through a user interface on the remote device.

20. The method according to claim 18, further comprising:
sending status information of the one or more batteries over the first wireless communication network; and
sending the status information to the remote device over the second wireless communication network.
